(19) United States
(12) Patent Application Publication
(10) Pub. No.: US 2012/0248843 A1
(43) Pub. Date: Oct. 4, 2012

(54) ROTATIONALLY-MOLDED FURNITURE

(76) Inventors: John D. Sinchok, Hudson, OH (US); Thomas Joseph Manion, Tallmadge, OH (US)

(21) Appl. No.: 13/438,349

(22) Filed: Apr. 3, 2012

Related U.S. Application Data
(60) Provisional application No. 61/471,521, filed on Apr. 4, 2011.

(51) Int. Cl. A47C 7/02; B23P 11/00; A47B 3/06

(52) U.S. Cl. 297/440.1; 108/158.12; 29/525.01; 29/426.1

(57) ABSTRACT

Rotationally-molded outdoor furniture takes up little space when unassembled, but is easily assembled and durable requiring only one fastener to support the weight of an adult. In one embodiment the furniture may include two side supports, a forward support, a seat member and a seat back. Male extensions that are positioned within female grooves may be used to attach the components together.

This application claims priority from provisional application U.S. Ser. No. 61/471,521 titled ROTATIONALLY-MOLDED FURNITURE, filed Apr. 4, 2001, which is incorporated in its entirety herein by reference.

### I. BACKGROUND

A. Field of Invention

This invention generally relates to methods and articles concerning furniture and more specifically relates to methods and articles concerning furniture made from a rotational molding manufacturing process, and even more specifically to rotationally-molded furniture which can be shipped in a very compact form and then be assembled using only five components plus a fastening means.

B. Description of the Related Art

It is well known to provide furniture for outdoor use, such as on a porch or patio, or in harsh environments, such as in prisons or schools. While much furniture is upholstered with fabric, the harsh environments described above are unsuitable for upholstered fabric furniture. Therefore, outdoor furniture has typically been made of durable materials such as metal or wood. Some outdoor furniture has been made of plastic, but such previous designs were often flimsy and not structurally strong and durable. In addition, such furniture often required disproportionately large shipping costs, as the shape of the furniture took up large volumes, requiring fewer pieces of furniture per shipping container, thereby raising the cost of shipping the furniture. It is desirable, however, to provide an easy way for furniture manufacturers to store and ship furniture pieces using a small amount of space. Additionally, when consumers purchase furniture, it is desirable that the consumer be able to easily transport the furniture from the place of purchase to the desired location of the furniture. Moreover, desirable that the furniture be easily assembled. Further, outdoor furniture needs to be resilient to weather and the elements.

What is needed, then, is durable outdoor furniture that is easily and inexpensively transported, stored, and assembled. The present invention is rotationally-molded outdoor furniture sized for usage by adults that ships in a collapsed, dense, configuration that is a much smaller volume than the same furniture occupies in its assembled form. Another advantage is that the inventive furniture is easily assembled and durable, while requiring only one fastener to support the weight of a typical sized human adult.

### II. SUMMARY

According to one embodiment of this invention, a rotationally-molded article of furniture comprises: (A) a first rotationally-molded side support comprising: a forward channel; a rearward channel; an intermediate channel; a first female groove positioned within the forward channel; a first female groove positioned within the rearward channel; and, a first female groove positioned within the intermediate channel; (B) a second rotationally-molded side support oppositely disposed from the first rotationally-molded side support, the second rotationally-molded side support comprising: a forward channel; a rearward channel; an intermediate channel; a first female groove positioned within the forward channel; a first female groove positioned within the rearward channel; and, a first female groove positioned within the intermediate channel; (C) a rotationally-molded forward support interposed between the first and second rotationally-molded side supports, the rotationally-molded forward support comprising: a first male extension positioned within the first female groove within the forward channel in the first side support; and, a second male extension positioned within the first female groove within the forward channel in the second side support; (D) a rotationally-molded seat member interposed between the first and second rotationally-molded side supports, the rotationally-molded seat member comprising: a first male extension positioned within the first female groove within the intermediate channel in the first side support; and, a second male extension positioned within the first female groove within the intermediate channel in the second side support; (E) a rotationally-molded seat back interposed between the first and second rotationally-molded side supports, the rotationally-molded seat back comprising: a first male extension positioned within the first female groove within the rearward channel in the first side support; and, a second male extension positioned within the first female groove within the rearward channel in the second side support; and, (F) a fastener that attaches the rotationally-molded seat back to the rotationally-molded seat member.

According to another embodiment of this invention, a rotationally-molded table comprises: (A) a first rotationally-molded side support comprising: a forward channel; a rearward channel; an intermediate channel; a first female groove positioned within the forward channel; a first female groove positioned within the rearward channel; and, a first female groove positioned within the intermediate channel; (B) a second rotationally-molded side support oppositely disposed from the first rotationally-molded side support, the second rotationally-molded side support comprising: a forward channel; a rearward channel; an intermediate channel; a first female groove positioned within the forward channel; a first female groove positioned within the rearward channel; and, a first female groove positioned within the intermediate channel; (C) a rotationally-molded forward support interposed between the first and second rotationally-molded side supports, the rotationally-molded forward support comprising: a first male extension positioned within the first female groove within the forward channel in the first side support; and, a second male extension positioned within the first female groove within the forward channel in the second side support; (D) a rotationally-molded rearward support interposed between the first and second rotationally-molded side supports, the rotationally- molded rearward support comprising: a first male extension positioned within the first female groove within the rearward channel in the first side support; and, a second male extension positioned within the first female groove within the rearward channel in the second side support; (E) a rotationally-molded top member interposed between the first and second rotationally-molded side supports, the rotationally-molded top member comprising: a first male extension positioned within the first female groove within the intermediate channel in the first side support; and, a second male extension positioned within the first female groove within the intermediate channel in the second side support; and, wherein the rotationally-molded top member is selectively removable to provide access to a storage cavity between the first and second rotationally-molded side supports and between the rotationally-molded forward support and the rotationally-molded rearward support.

According to yet another embodiment of this invention, a method of assembling a rotationally-molded article of furniture comprising the steps of: (A) providing a first rotationally-molded side support comprising: a forward channel; a rearward channel; an intermediate channel; a first female groove positioned within the forward channel; a first female groove positioned within the rearward channel; and, a first female groove positioned within the intermediate channel; (B) providing a second rotationally-molded side support comprising: a forward channel; a rearward channel; an intermediate channel; a first female groove positioned within the forward channel; a first female groove positioned within the rearward channel; and, a first female groove positioned within the intermediate channel; (C) providing a rotationally-molded forward support comprising: a first male extension; and, a second male extension; (D) providing a rotationally-molded seat member comprising: a first male extension; and, a second male extension; (E) providing a rotationally-molded seat back comprising: a first male extension; and, a second male extension; (F) interposing the rotationally-molded forward support between the first and second rotationally-molded side supports; (G) positioning the first male extension of the rotationally-molded forward support within the first female groove within the forward channel in the first side support; (H) positioning the second male extension of the rotationally-molded forward support within the first female groove within the forward channel in the second side support; (I) interposing the rotationally-molded seat member between the first and second rotationally-molded side supports; (J) positioning the first male extension of the rotationally-molded seat member within the first female groove within the intermediate channel in the first side support; (K) positioning the second male extension of the rotationally-molded seat member within the first female groove within the intermediate channel in the second side support; (L) interposing the rotationally-molded seat back between the first and second rotationally-molded side supports; (M) positioning the first male extension of the rotationally-molded seat back within the first female groove within the rearward channel in the first side support; (N) positioning the second male extension of the rotationally-molded seat back within the first female groove within the rearward channel in the second side support; and, (O) using a fastener to attach the rotationally-molded seat back to the rotationally-molded seat member.

Many benefits and advantages of the invention will become apparent to those skilled in the art to which it pertains upon a reading and understanding of the following detailed specification.

### III. BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is a perspective right side view of a rotationally-molded couch and a rotationally-molded coffee table.

FIG. 2 is perspective side view of a rotationally-molded chair and a rotationally-molded side table.

FIG. 3 is a front view of the rotationally-molded chair shown in FIG. 2.

FIG. 4 is a right side view of the rotationally-molded chair shown in FIG. 2.

FIG. 5 is a left side view of the rotationally-molded chair shown in FIG. 2.

FIG. 6 is a rear view of the rotationally-molded chair shown in FIG. 2.

FIG. 7 is a close-up view of a portion of the rotationally-molded chair shown in FIG. 6, specifically showing the fastening means.

FIG. 8 is a close-up bottom view of a portion of the rotationally-molded chair shown in FIG. 2.

FIG. 9 is an exploded view of the pieces of the rotationally-molded chair shown in FIG. 2 when disassembled.

FIG. 10 is an exploded view of the reverse sides of the pieces of the rotationally-molded chair shown in FIG. 9.

FIG. 11 is a close-up view of the second side support shown in FIG. 9.

FIG. 12 is a close-up view of the forward support shown in FIG. 9.

FIG. 13 is a close-up view of the seat ember shown in FIG. 9.

FIG. 14 is a close-up view of the reverse side of the seat member shown in FIG. 13.

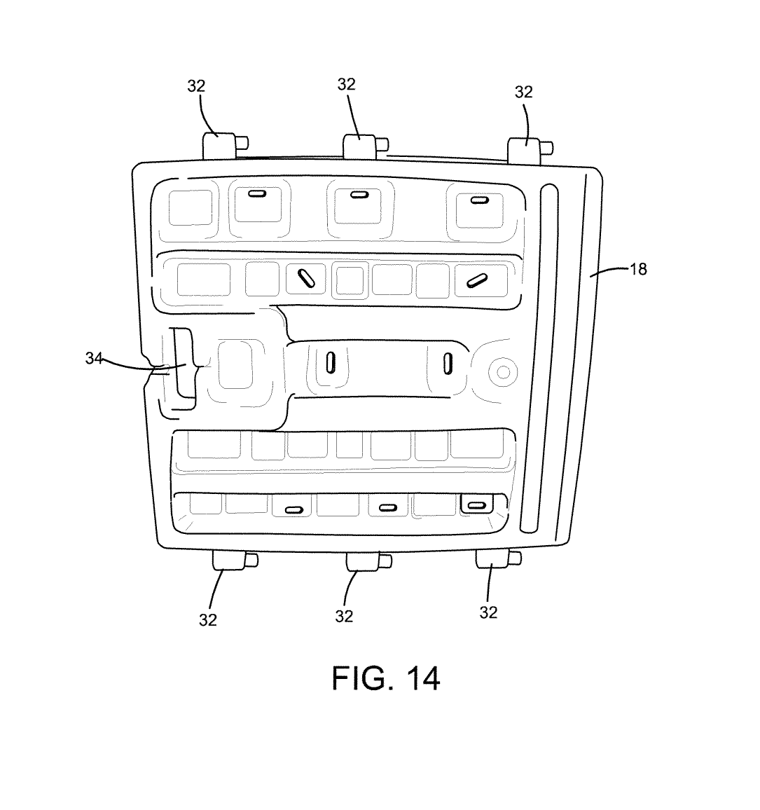

FIG. 15 is a close-up view of the seat back shown in FIG. 9.

FIG. 16 is a side view of the side table shown in FIG. 2.

FIG. 17 is an end view of the side table shown in FIG. 2.

FIG. 18 is a top view of the side table shown in FIG. 2.

FIG. 19 is a close-up view of the side table shown in FIG. 2.

FIG. 20 is a top view of the side table, with the top member removed, shown in FIG. 2.

FIG. 21 is a close-up view of the unassembled rotationally-molded chair shown in FIG. 2.

FIG. 22 is a perspective view of the storage box.

### IV. DETAILED DESCRIPTION

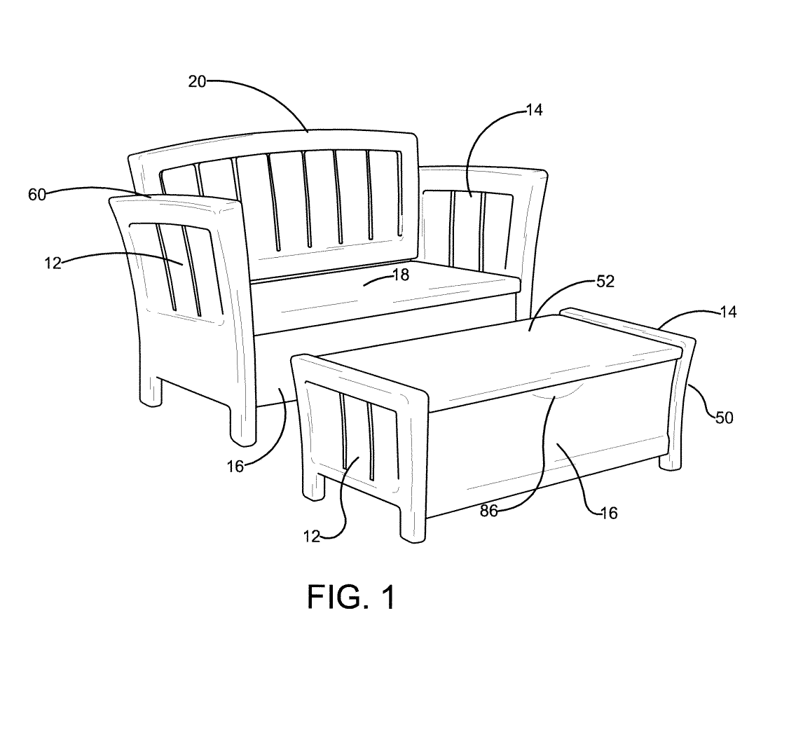

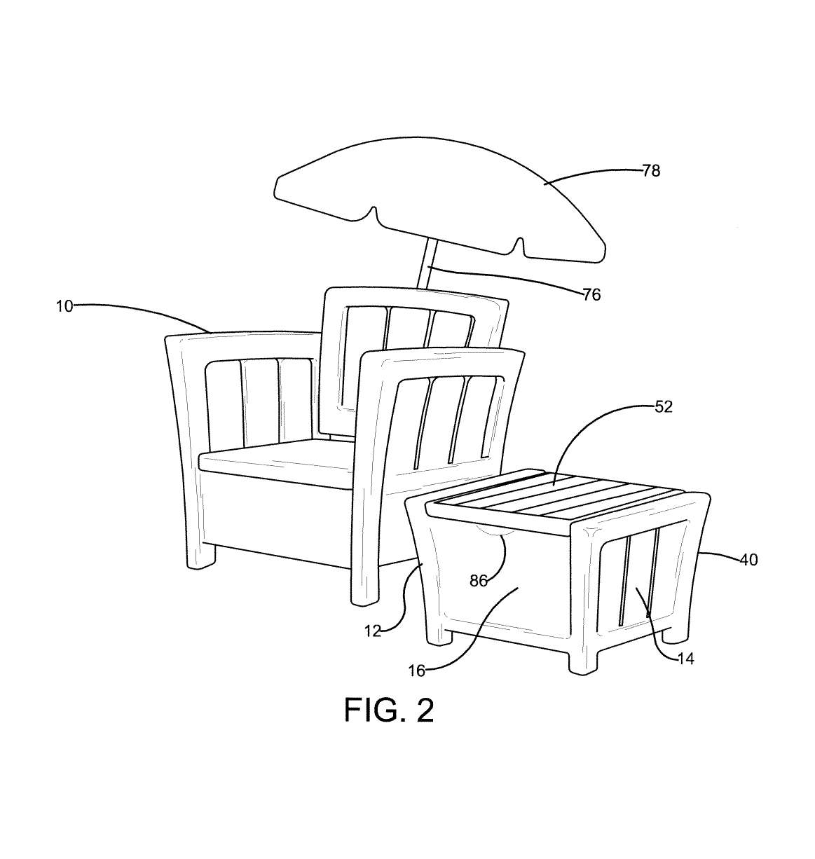

Referring now to the drawings wherein the showings are for purposes of illustrating embodiments of the invention only and not for purposes of limiting the same, and wherein like reference numerals are understood to refer to like components, FIGS. 1 and 2 show outdoor furniture for adults made of rotationally-molded pieces according to this invention. The process of rotational molding is well known to one of ordinary skill in the art; therefore, further detail on the process of rotationally molding pieces will not be discussed herein. While the furniture shown in FIGS. 1 and 2 is a rotationally-molded couch 60, a rotationally-molded chair 10, a rotationally-molded end table 40, and a rotationally-molded coffee table 50, it is to be understood that the inventive aspects of the disclosed furniture of this invention could be applied to other rotationally-molded articles of furniture chosen with the sound judgment of a person of skill in the art, including Adirondack style chairs, rocking chairs, dining tables, chests, foot stools, and ottomans, benches, wardrobes, storage units, chest of drawers and may have non-outdoor applications as well, such as the harsh environments of schools, prisons, shopping malls, etc.

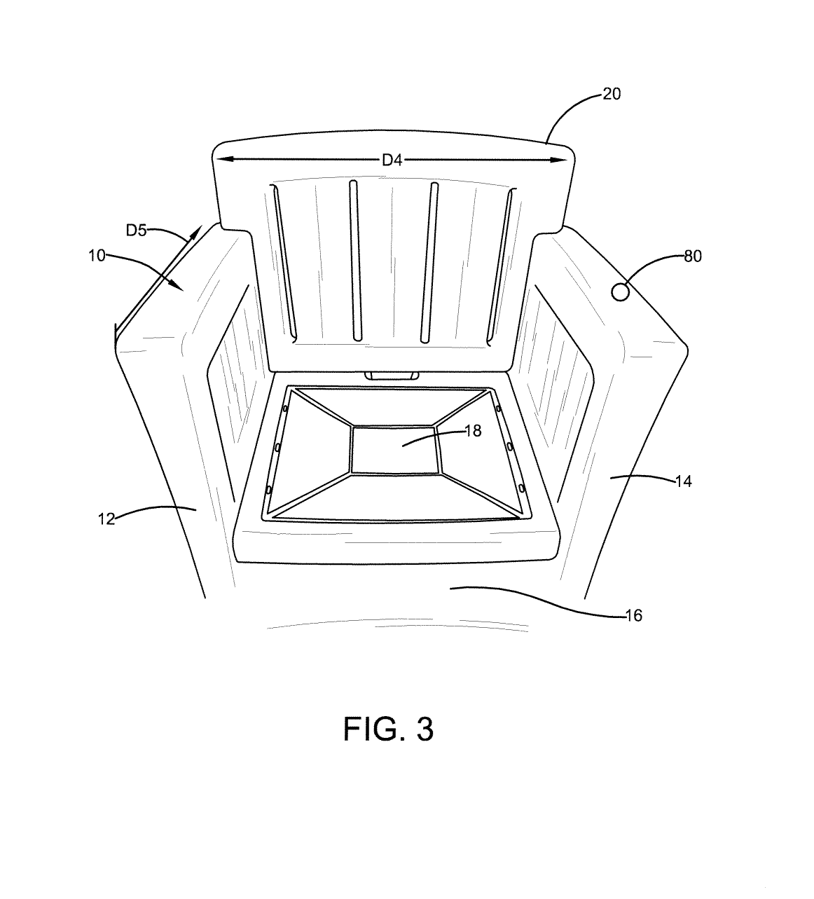

Reference is now made to FIGS. 1 through 6 to illustrate the embodiments of the invention. Specifically, FIG. 3 shows a front view of the assembled rotationally-molded chair 10 in FIG. 2. The component pieces of the chair 10 include a rotationally-molded first side support 12, a rotationally-molded second side support 14, a rotationally-molded seat member 18, a rotationally-molded forward support 16, and a rotationally-molded seat back 20. The chair 10 shown is of sufficient size and strength to support a typical human adult sitting on the rotationally-molded seat member 18.

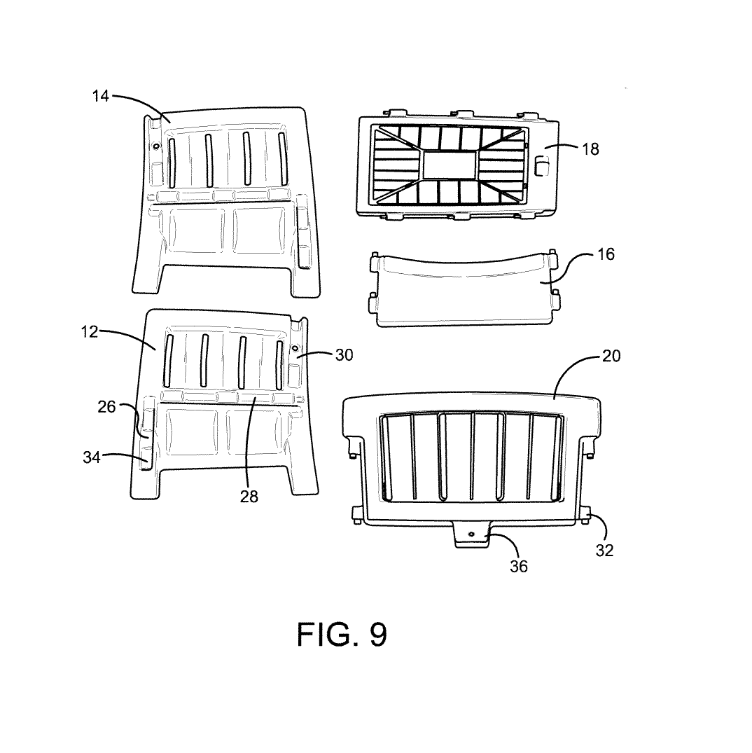

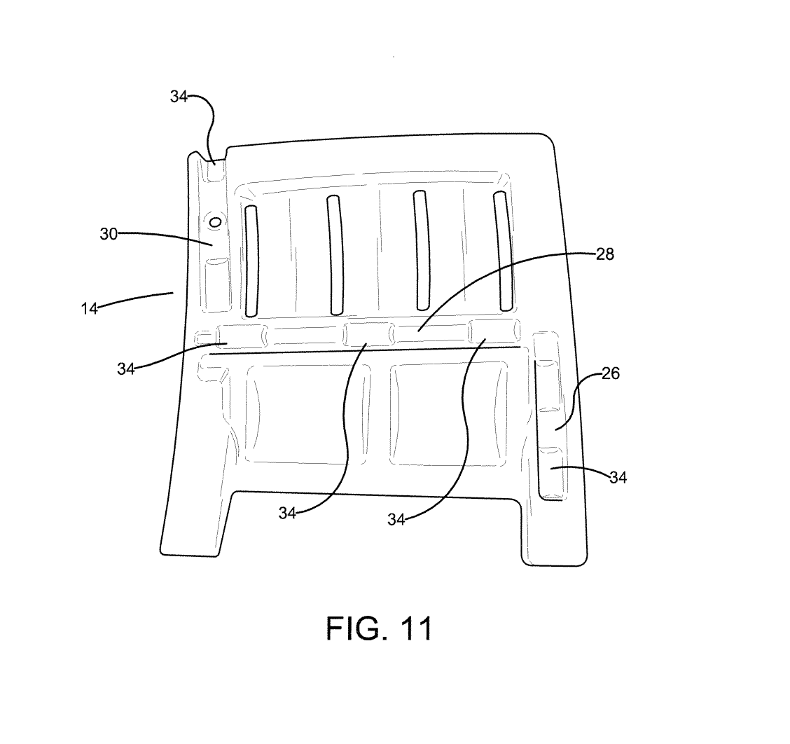

As shown in FIG. 9, the first and second side supports 12, 14 further include a forward channel 26 an intermediate channel 28 and a rearward channel 30. As further detailed in FIG. 11, each side support further has at least one female groove 34 inside each forward channel 26, at least one female groove 34 inside each rearward channel 30, and at least one female groove 34 inside the intermediate channel 28. In another embodiment, the first and second side supports may have one or more male connectors (which may be similar to the male connectors 32 shown on the seat back 20 in FIG. 9) along each forward channel 26, each rearward channel 30, or the intermediate channel 28.

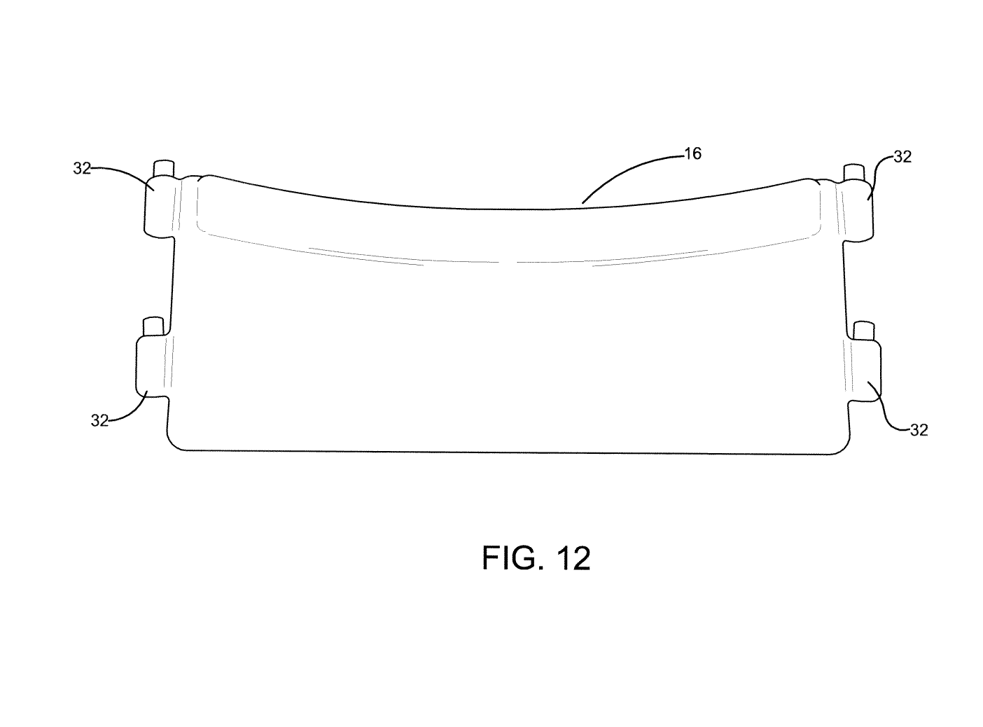

Reference now is made to FIGS. 9 and 12 to further illustrate the embodiments of the invention. The forward support 16 may have a first male extension 32 which can be operatively coupled to at least one female groove 34 inside the forward channel 26 in the first side support 12. Alternatively, the forward support 16 may have at least one female groove (which may be similar to the female groove 34 shown on the side supports 12, 14) which can be operatively coupled to a first male extension inside the forward channel 26 in the first side support 12. Additionally, the forward support 16 may have at least one additional male extension 32 which can be operatively coupled to at least one female groove 34 inside the forward channel 26 in the second side support 14. Alternatively, the forward support 16 may have at least one female groove (which may be similar to the female groove 34 shown on the side supports 12, 14) which can be operatively coupled to a second male extension inside the forward channel 26 in the second side support 14.

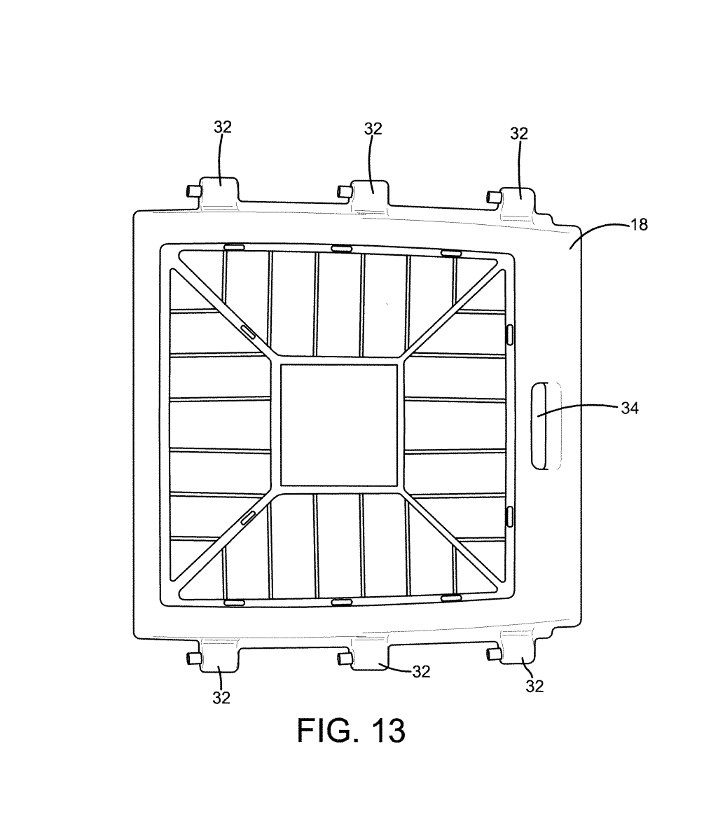

Reference now is made to FIGS. 9 and 13 to further illustrate the embodiments of the invention. The seat member 18 may have at least one male extension 32 which can be operatively coupled to at least one female groove 34 inside the intermediate channel in the first side support. Alternatively, the seat member 18 can include at least one female groove (which may be similar to the female groove 34 shown on the side supports 12, 14) which can be operatively coupled to a male extension inside the intermediate channel in the first side support. The seat member 18 may have at least a second male extension 32 which can be operatively coupled to at least one female groove 34 inside the intermediate channel 28 in the second side support 14. Alternatively, the seat member 18 can include at least one female groove (which may be similar to the female groove 34 shown on the side supports 12, 14) which can be operatively coupled to a male extension inside the intermediate channel 28 in the second side support 14.

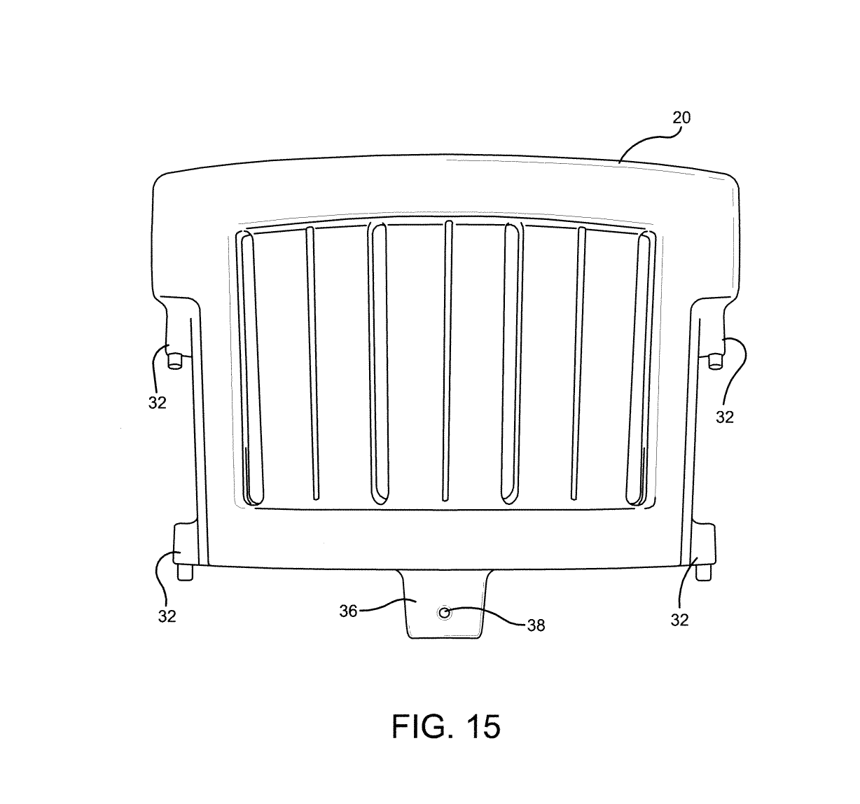

Reference now is made to FIG. 15 to further illustrate the embodiments of the invention. The seat back 20 may have at least a first male extension 32 operatively coupled to at least one female groove 34 inside the rearward channel 30 in the first side support. The seat back 20 may have at least a second male extension 32 operatively coupled to at least one female groove 34 inside the rearward channel 30 in the second side support 14. In another embodiment, the seat back 20 may contain female grooves (which may be similar to the female groove 34 shown on the side supports 12, 14) which are operatively coupled to male extensions in the first and second side supports 12 and 14.

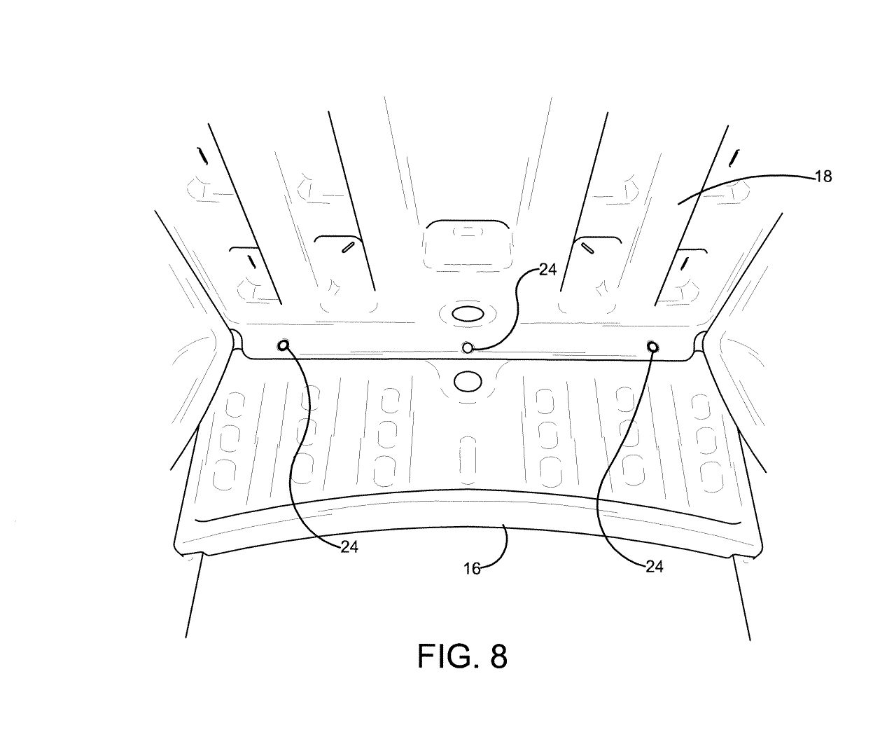

According to yet another embodiment of this invention, a method of assembling a rotationally-molded article of furniture may comprise the steps of: (A) placing the first side support 12 in an upright position such that the base of its legs 66 are positioned on a flat surface and placing the second side support 14 across from the first side support 12 in an upright position such that the base of its legs 66 are on the flat surface and the forward 26, intermediate, 28 and rearward 30 channels of each side support 12 and 14 are facing inward toward one another; (B) placing the forward support 16 between the first and second side supports 12 and 14 and coupling the forward support 16 to the first and second side supports 12 and 14 using the male extensions 32 and the female grooves 34 inside each piece by coupling a first male extension 32 on the forward support 16 to at least one female groove 34 inside the forward channel 26 in the first side support 12, and by coupling a second male extension 32 on the forward support 16 to at least one female groove 34 inside the forward channel 26 in the second side support 14; (C) horizontally interposing the seat member 18 between the first and second side supports by coupling the seat member 18 to the first and second side supports using the male extensions 32 and the female grooves 34 inside each piece, this can be done by coupling a first male extension 32 on the seat member 18 to at least one female groove 34 inside the intermediate channel 28 in the first side support 12, and by coupling a second male extension 32 on the seat member 18 to at least one female groove 34 inside the intermediate channel 28 in the second side support 14; (D) coupling the seat back 20 to the side supports using the male extension 32 and the female groove 34 inside each piece, this can be done by coupling a first male extension 32 on the seat back 20 to at least one female groove 34 inside the rearward channel in the first side support, and by coupling a second male extension 32 on the seat member 18 to at least one female groove 34 inside the rearward channel in the second side support 14; and (E) securing the seat member 18 to the seat back 20 with at least one fastening means 22. In one embodiment, the fastening means 22 is a bolt or screw with a nut, although any fastener chosen with sound engineering judgment could be used. Finally, (F) three additional secondary fastening means 24 may be optionally added to secure the forward support 16 to the seat member 18, as shown in FIG. 8. The optional secondary fastening means may be bolts or screws with a nut, although any fastener chosen with sound engineering judgment could be used.

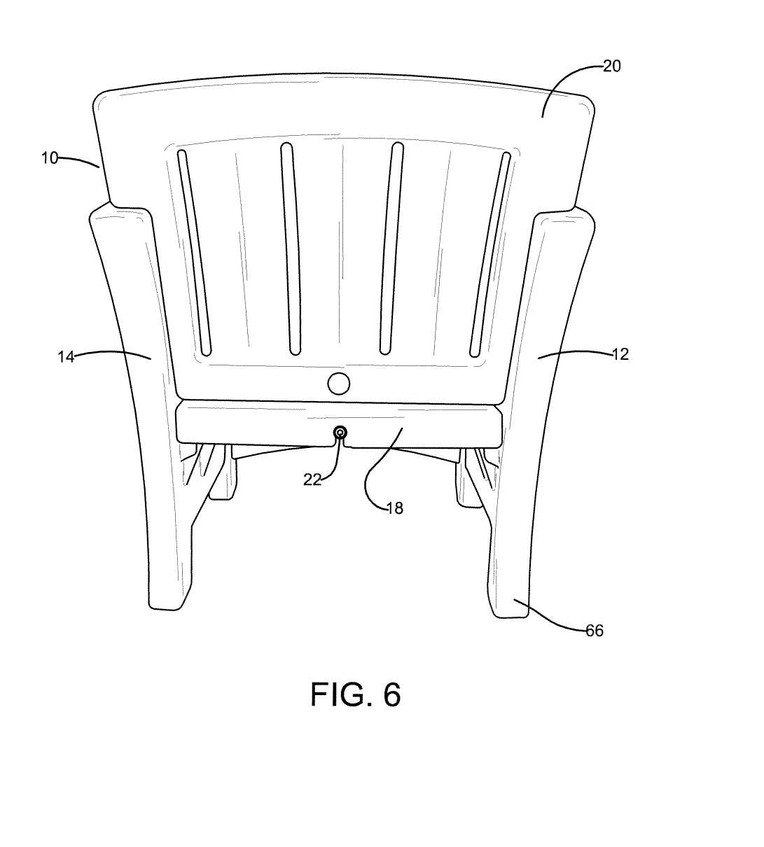

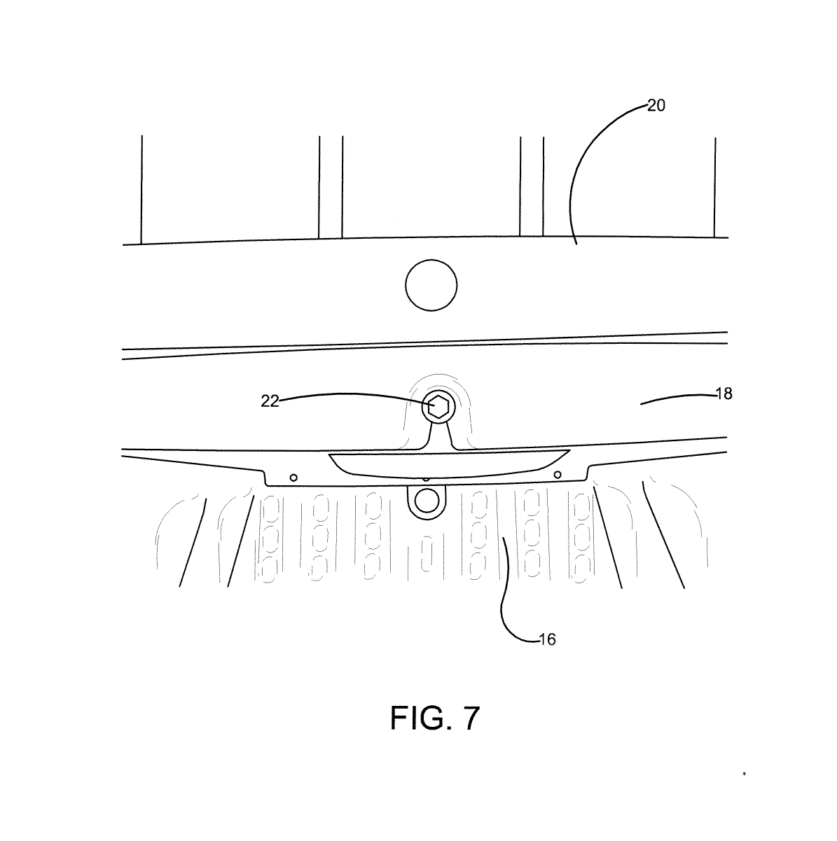

Reference is now made to FIG. 15 to illustrate the seat back 20 which may include a notch tongue 36 and a notch opening 38. Reference to FIG. 13 illustrates the seat member 18 which may include a slot 34. FIGS. 6 and 7 show the seat member 18 operatively attached to the seat back 20. To accomplish this, the notch tongue 36 is inserted into the slot 34 and the fastening means 22 is inserted into the notch opening 38. FIG. 6 illustrated a rear view of the fully assembled rotationally-molded chair. The fastening means 22 can be any number of objects including a bolt, pin, bar, rod, screw, latch, or any other suitable faster known in the art. Thus, the rotationally-molded patio chair according to the invention is composed of five elements plus one fastening means 22.

The fastening means 22 is the only one needed to bear the weight of an adult user. However, additional secondary fastening means 24 such as screws may be optionally added to secure the forward support 16 to the seat member 18 as shown in FIG. 8.

In the same manner as the rotationally-molded chair 10, the rotationally-molded couch 60, the rotationally-molded coffee table 50 and the rotationally-molded side or end table 40 comprise similar rotationally-molded component parts. Reference now is made to FIG. 1 to further illustrate these embodiments of the invention. The component pieces of the couch 60, which include a rotationally-molded first side support 12, a rotationally-molded second side support 14, a rotationally-molded seat member 18, a rotationally-molded forward support 16, and a rotationally-molded seat back 20. Like the chair, the first and second side supports 12 and 14 in the couch contain a forward channel 26 and intermediate channel 28 and a rearward channel 30. Each side support further has either a female groove 34 or a male extension 32 inside each forward channel 26, inside each rearward channel 30, and inside the intermediate channel 28. The forward support 16 can have a male extension 32 or a female groove 34 which can be operatively coupled to the forward channel 26 in the first side support. Additionally, the forward support 16 further has a second female groove 34 or a male extension 32 which can be operatively coupled to the forward channel 26 in the second side support 14. The couch 60 may be assembled in the same manner as the chair 10, detailed above. The couch 60 shown is of sufficient size and strength to support at least two typical human adults sitting side by side on the rotationally-molded seat member 18.

The component pieces of the coffee table 50 include a rotationally-molded first side support 12, a rotationally-molded second side support 14, a rotationally-molded top member 52, a rotationally-molded forward support 16, and a rotationally-molded rearward support.

The component pieces of the side or end table 40 include a rotationally-molded first side support 12, a rotationally-molded second side support 14, a rotationally-molded top member 52, a rotationally-molded forward support 16, and a rotationally-molded rearward support.

The coffee table 50 and the side or end table 40 are assembled in the same manner as the chair 10, detailed above, except that the seat back 20 is replaced with the rearward support. Additionally, the seat member 18 is replaced with the top member 52.

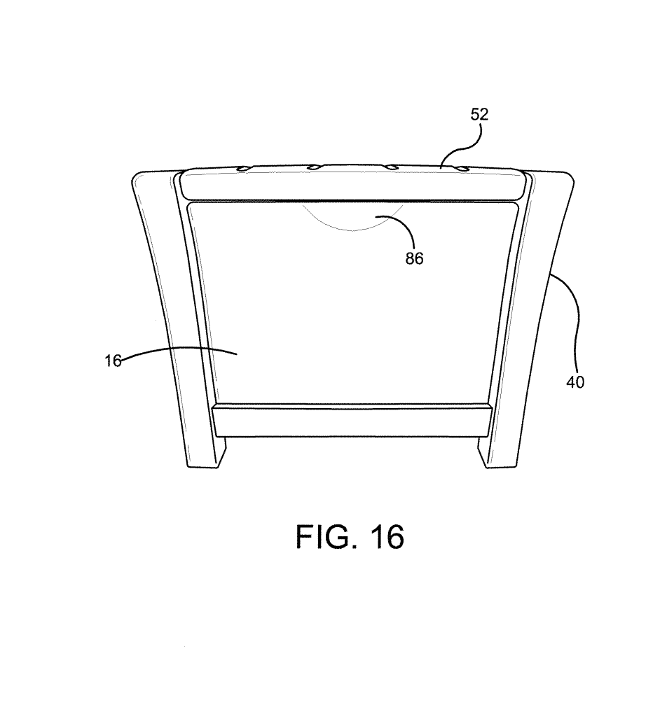

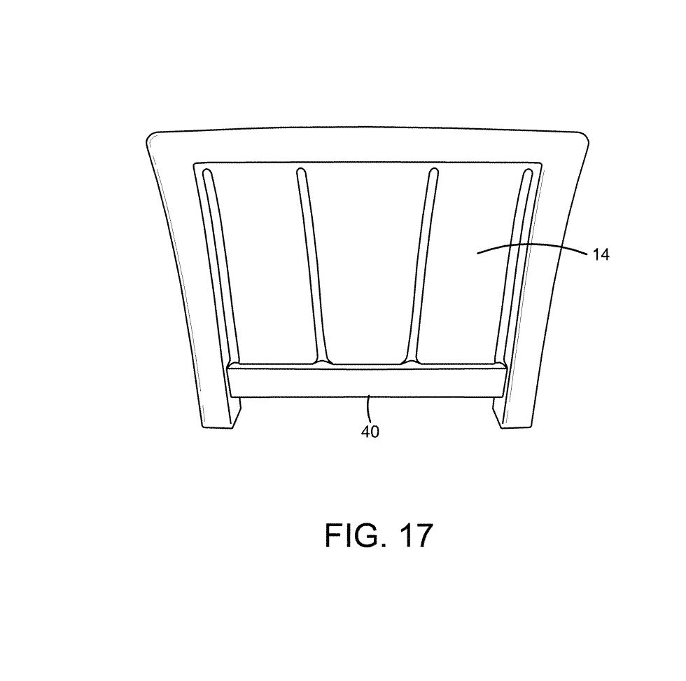

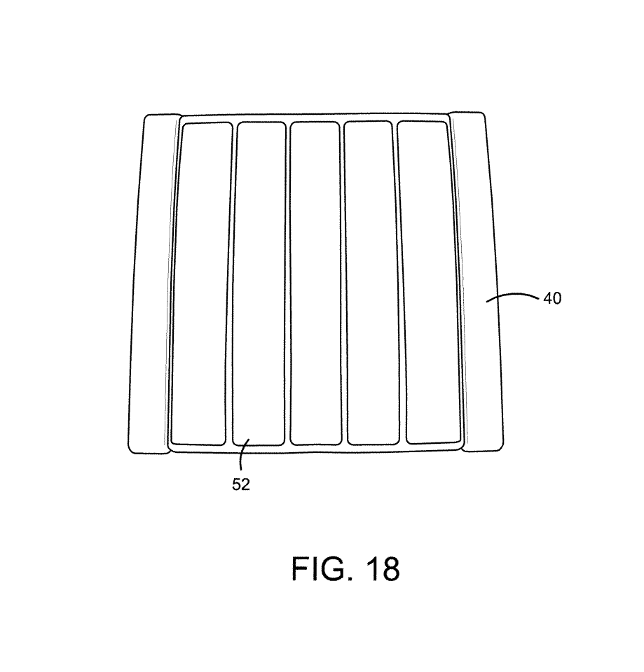

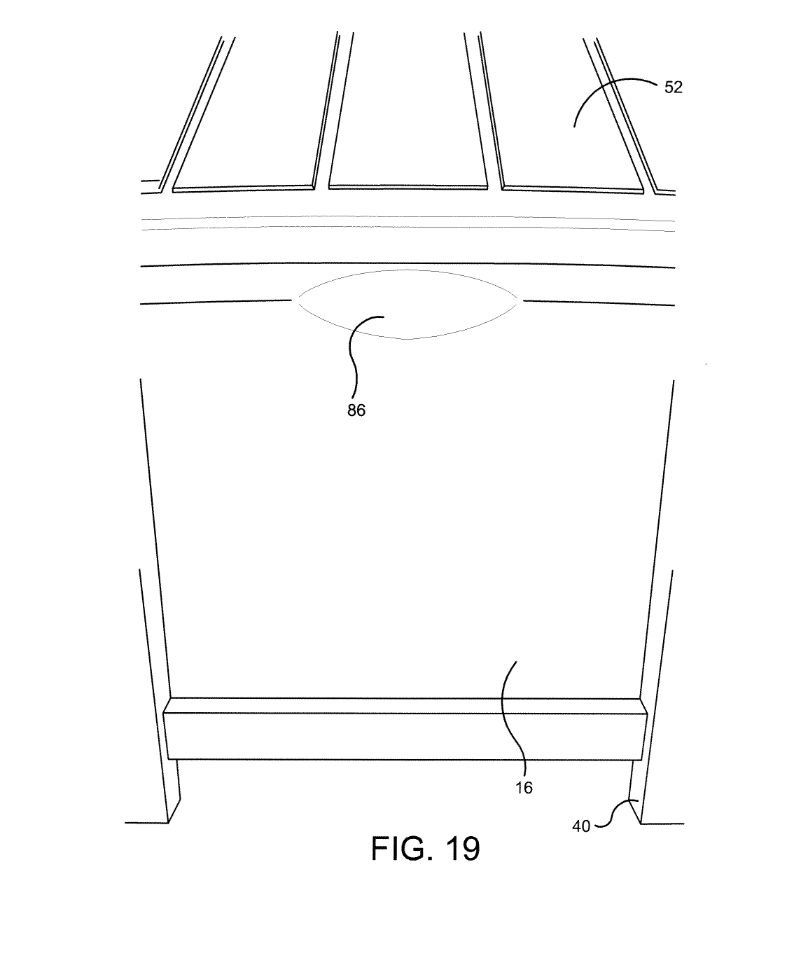

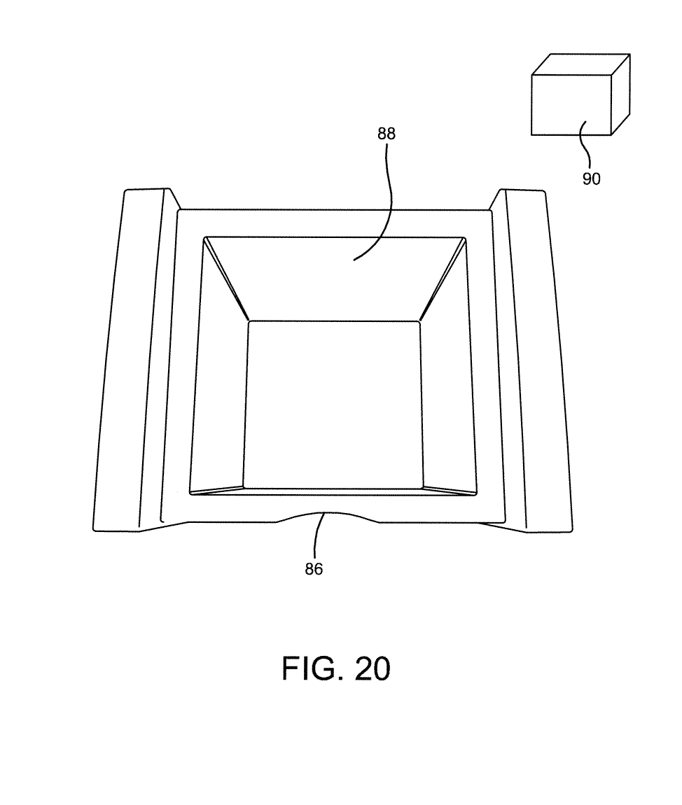

Reference is made now to FIGS. 16 through 20, showing another embodiment of the invention. The top member 52 of the coffee table 50 or the end table 40 may optionally include an indentation 86. The indentation 86 facilitates easy gripping and selective removal of the top member 52. The top member 52 may be selectively removed and replaced from the remainder of the unit. Thus, the first side support 12, second side support 14, forward support 16, and rearward support form a cavity 88. The cavity 88 forms a handy storage space for a variety of objects, including drinks or food. The cavity 88 may also include a liner 90, chosen according to sound engineering judgment, such as plastic or an insulating liner, to improve the temperature insulating ability of the cavity 88 or to assist in the cleaning of the cavity 88. The cavity 88 can be filled with ice, toys, or any other item which the user might like to store inside the cavity 88.

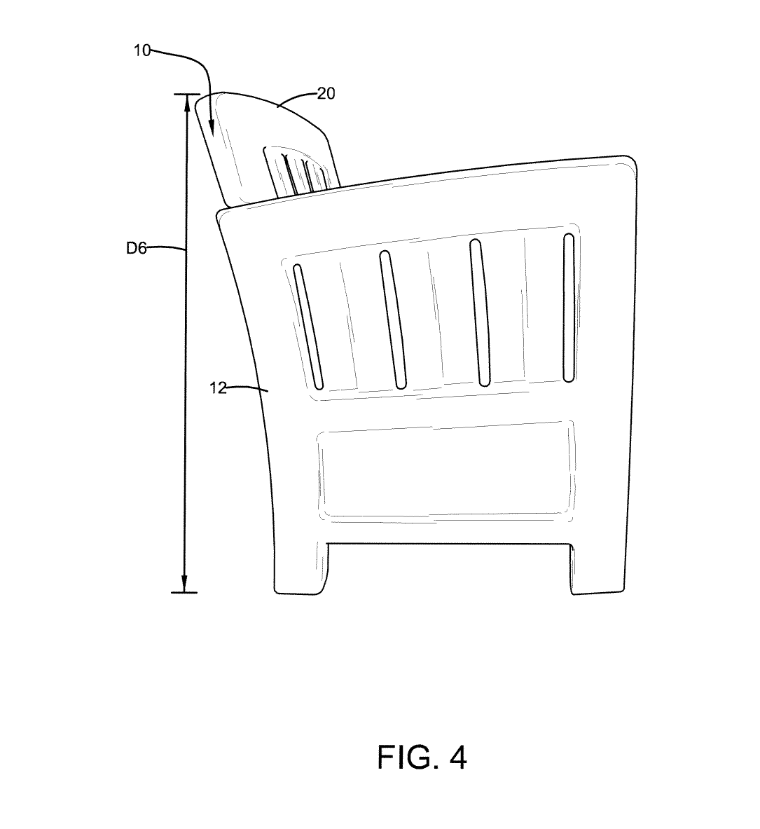

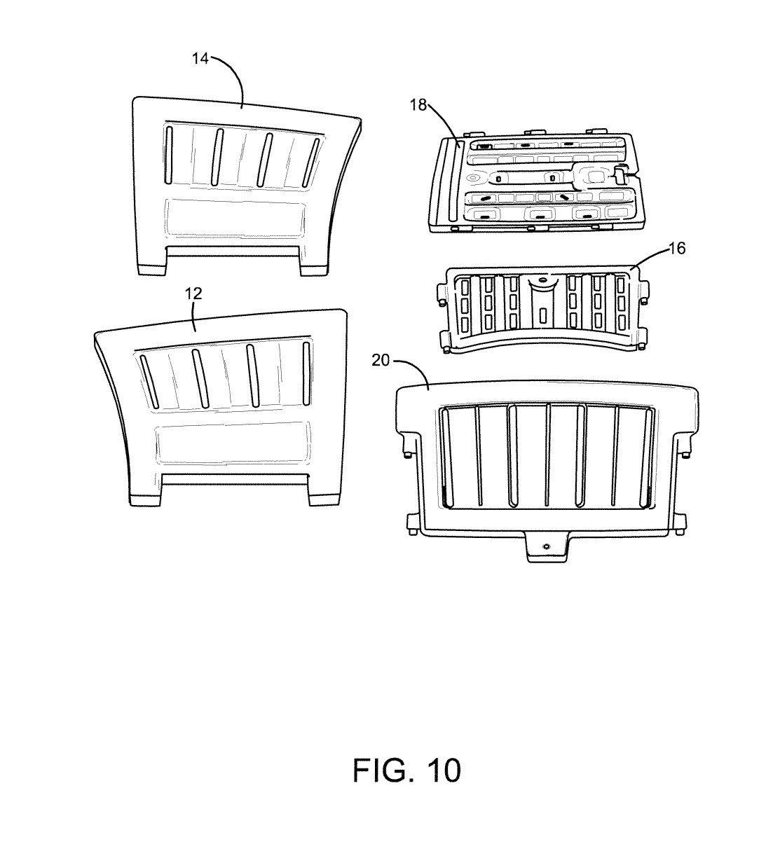

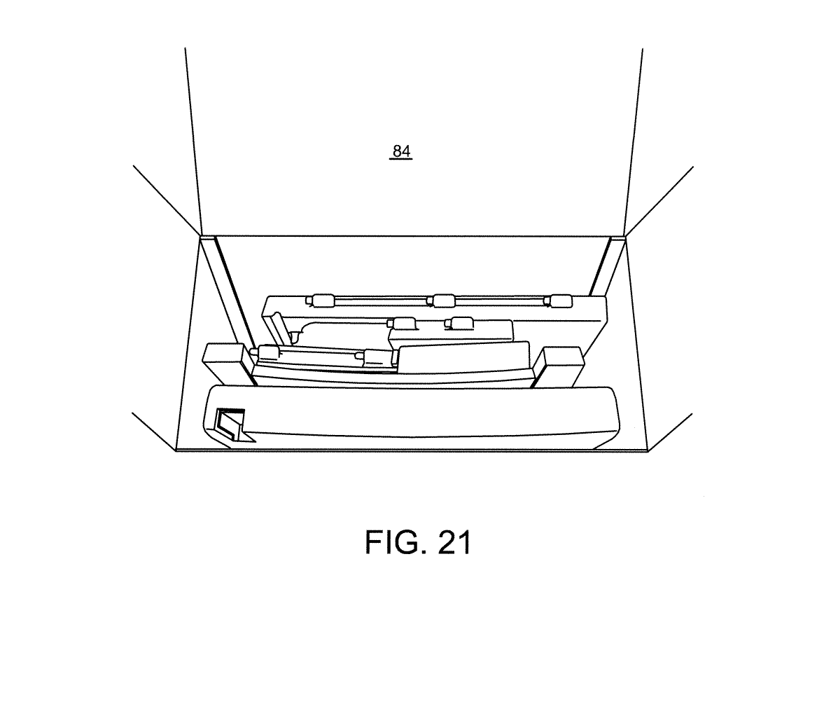

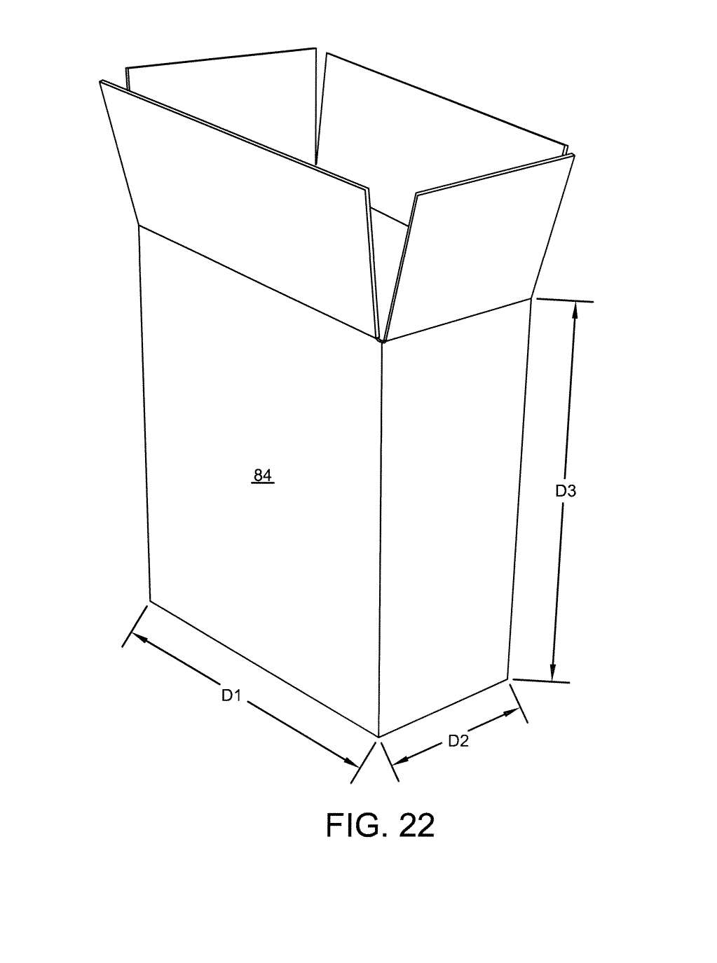

Referring now to FIGS. 21 through 23, the rotationally-molded furniture as described above disassembles into planar components for convenient and inexpensive shipping. The planar shape of each component is shown, for example, in FIGS. 9, 10 and 21. The chair 10 shown in FIG. 2, when unassembled can be packed into a storage/shipping box 84 having a width D1 of 27.25 inches, a depth D2 of 14 inches and a height D3 of 31 inches. This box 84, as described, has a volume of only 11,826.5 cubic inches. However, with reference to FIGS. 3 and 4, the chair 10 in its assembled form, has a width D4 of 32 inches, a depth D5 of 26 inches, and a height D6 of 35.5 inches, thereby occupying a volume of 29,536 cubic inches. Thus, the ratio of volume of the unassembled chair 10 to the volume of the assembled chair 10 is only 11,826.5 cubic inches divided by 29,536 cubic inches or approximately 40%. The smaller the ratio of the furniture when unassembled to the same furniture when assembled, the more advantages for shipping purposes. In another embodiment, the ratio may be less than 40%. In other embodiments, the ratio may be 50% or less, 60% or less, 70% or less, 80% or less, or 90% or less.

In one embodiment, the furniture can be manufactured with indicia molded or otherwise affixed in the seat back 20 or other areas of the chair 10. These indicia can be designs attractive to the purchaser and user of the chair 10, such as college mascots, attractive designs such pineapple, or corporate logos, etc. Further, the inventive furniture can be manufactured with indicia, such as wood grain, molded into the surface of the plastic.

In another embodiment, there may be included a fleck or other decorative material in the plastic to make the furniture appealing to the eye. In yet another embodiment, the thickness of the plastic composing one of the walls of the rotationally molded furniture may be within the range of 0.090 to 0.250 of an inch thick to give the furniture a heavy and sturdy feel and also to keep the outdoor furniture from blowing away or moving when exposed to the elements. In one embodiment, the thickness of the plastic composing at least one wall of the rotationally molded furniture may be about 0.125 of an inch thick.

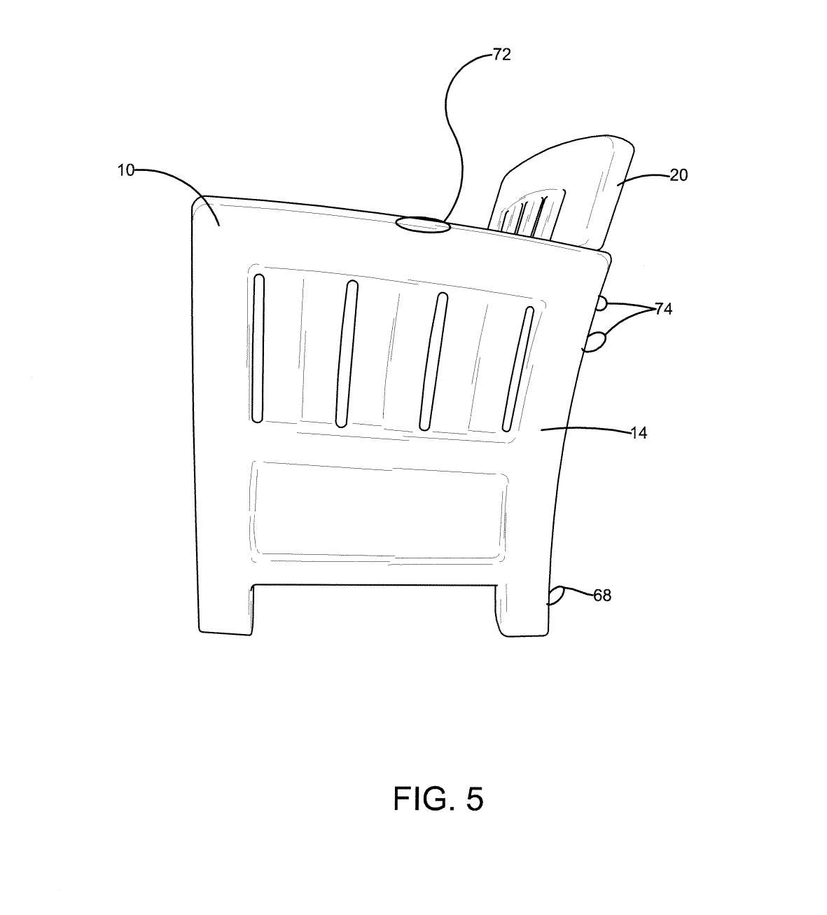

With reference to FIG. 5, the inventive furniture may include a securement device to facilitate chaining the furniture to a location such as a restaurant deck, the porch of a house, etc. This may be accomplished via a loop or ring, such as an eye bolt 68 molded into the leg of the furniture to facilitate such securement. The rotationally-molded components may include hollow portions. Additionally, the furniture may include a filling device 70 and cap 72 on first and second side supports 12 and 14 to facilitate the filling of the hollow portions on the side supports with sand or other weight increasing elements to lessen the likelihood of wind blowing the furniture out of place. In one embodiment, the filing device is simply an opening on a top surface of the first and second side supports 12 and 14, or other generally horizontal surface into which can be placed a selectively removeable cap 72. The cap 72 can be removed and then the weight increasing element can be added. Once the desired amount of weight increasing element has been added, the cap 72 can be replaced onto the opening.

In some embodiments, the furniture may include a drink holder 80. Another embodiment includes structure 74 to selectively receive an umbrella pole 76, so that the umbrella 78 may be displayed over the chair 10 providing shelter for the user.

Numerous embodiments have been described, hereinabove. It will be apparent to those skilled in the art that the above methods and apparatuses may incorporate changes and modifications without departing from the general scope of this invention. The materials used to make the cap can be any chosen with the sound judgment of a person of skill in the art. It is intended to include all such modifications and alterations in so far as they come within the scope of the appended claims or the equivalents thereof.

Having thus described the invention, it is now claimed:

I/We claim:

1. A rotationally-molded article of furniture comprising:
(A) a first rotationally-molded side support comprising:
a forward channel;
a rearward channel;
an intermediate channel;
a first female groove positioned within the forward channel;
a first female groove positioned within the rearward channel; and,
a first female groove positioned within the intermediate channel;
(B) a second rotationally-molded side support oppositely disposed from the first rotationally-molded side support, the second rotationally-molded side support comprising:
a forward channel;
a rearward channel;
an intermediate channel;
a first female groove positioned within the forward channel;
a first female groove positioned within the rearward channel; and,
a first female groove positioned within the intermediate channel;
(C) a rotationally-molded forward support interposed between the first and second rotationally-molded side supports, the rotationally-molded forward support comprising:
a first male extension positioned within the first female groove within the forward channel in the first side support; and,
a second male extension positioned within the first female groove within the forward channel in the second side support;
(D) a rotationally-molded seat member interposed between the first and second rotationally-molded side supports, the rotationally-molded seat member comprising:
a first male extension positioned within the first female groove within the intermediate channel in the first side support; and,
a second male extension positioned within the first female groove within the intermediate channel in the second side support;
(E) a rotationally-molded seat back interposed between the first and second rotationally-molded side supports, the rotationally-molded seat back comprising:
a first male extension positioned within the first female groove within the rearward channel in the first side support; and,
a second male extension positioned within the first female groove within the rearward channel in the second side support; and,
(F) a fastener that attaches the rotationally-molded seat back to the rotationally-molded seat member.

2. The rotationally-molded article of furniture of claim 1 wherein:
the first rotationally-molded side support further comprises:
a second female groove positioned within the forward channel;
a second female groove positioned within the rearward channel; and,
a second female groove positioned within the intermediate channel;
the second rotationally-molded side support further comprises:
a second female groove positioned within the forward channel;
a second female groove positioned within the rearward channel; and,
a second female groove positioned within the intermediate channel;
the rotationally-molded forward support further comprises:
a third male extension positioned within the second female groove within the forward channel in the first side support; and,
a fourth male extension positioned within the second groove within the forward channel in the second side support;
the rotationally-molded seat member further comprises:
a third male extension positioned within the second female groove within the intermediate channel in the first side support; and,
a fourth male extension positioned within the second female groove within the intermediate channel in the second side support; and,
the rotationally-molded seat back further comprises:
a third male extension positioned within the second female groove within the rearward channel in the first side support; and,
a fourth male extension positioned within the second female groove within the rearward channel in the second side support.

3. The rotationally-molded article of furniture of claim 2 wherein:
the first rotationally-molded side support further comprises a third female groove positioned within the intermediate channel;
the second rotationally-molded side support further comprises a third female groove positioned within the intermediate channel; and,
the rotationally-molded seat member further comprises:
a fifth male extension positioned within the third female groove within the intermediate channel in the first side support; and,
a sixth male extension positioned within the third female groove within the intermediate channel in the second side support.

4. The rotationally-molded article of furniture of claim 1 wherein:
the rotationally-molded seat back further comprises a notch tongue and a notch opening;
the rotationally-molded seat member further comprises a slot into which the notch tongue is inserted; and,
the fastener is inserted into the notch opening.

5. The rotationally-molded article of furniture of claim 4 wherein the fastener is a bolt.

6. The rotationally-molded article of furniture of claim 1 wherein the rotationally-molded article of furniture is a chair of sufficient size and strength to support a typical human adult sitting on the rotationally-molded seat member.

7. The rotationally-molded article of furniture of claim 1 wherein the rotationally-molded article of furniture is a couch of sufficient size and strength to support at least two typical human adults sitting side by side on the rotationally-molded seat member.

8. The rotationally-molded article of furniture of claim 1 wherein:
the first rotationally-molded side support is planar;
the second rotationally-molded side support is planar;
the rotationally-molded forward support is planar;
the rotationally-molded seat member is planar; and,
the rotationally-molded seat back is planar.

9. The rotationally-molded article of furniture of claim 1 wherein:
the rotationally-molded article of furniture when unassembled has a first volume and the rotationally-molded article of furniture when assembled has a second volume; and,
a ratio of the first volume to the second volume is 40% or less.

10. A rotationally-molded table comprising:
(A) a first rotationally-molded side support comprising:
a forward channel;
a rearward channel;
an intermediate channel;
a first female groove positioned within the forward channel;
a first female groove positioned within the rearward channel; and,
a first female groove positioned within the intermediate channel;
(B) a second rotationally-molded side support oppositely disposed from the first rotationally-molded side support, the second rotationally-molded side support comprising:
a forward channel;
a rearward channel;
an intermediate channel;
a first female groove positioned within the forward channel;
a first female groove positioned within the rearward channel; and, a first female groove positioned within the intermediate channel;
(C) a rotationally-molded forward support interposed between the first and second rotationally-molded side supports, the rotationally-molded forward support comprising:
a first male extension positioned within the first female groove within the forward channel in the first side support; and,
a second male extension positioned within the first female groove within the forward channel in the second side support;
(D) a rotationally-molded rearward support interposed between the first and second rotationally-molded side supports, the rotationally-molded rearward support comprising:
a first male extension positioned within the first female groove within the rearward channel in the first side support; and,
a second male extension positioned within the first female groove within the rearward channel in the second side support;
(E) a rotationally-molded top member interposed between the first and second rotationally-molded side supports, the rotationally-molded top member comprising:
a first male extension positioned within the first female groove within the intermediate channel in the first side support; and,
a second male extension positioned within the first female groove within the intermediate channel in the second side support; and,
wherein the rotationally-molded top member is selectively removable to provide access to a storage cavity between the first and second rotationally-molded side supports and between the rotationally-molded forward support and the rotationally-molded rearward support.

11. The rotationally-molded table of claim 10 wherein:
the first rotationally-molded side support further comprises:
a second female groove positioned within the forward channel;
a second female groove positioned within the rearward channel; and,
a second female groove positioned within the intermediate channel;
the second rotationally-molded side support further comprises:
a second female groove positioned within the forward channel;
a second female groove positioned within the rearward channel; and,
a second female groove positioned within the intermediate channel;
the rotationally-molded forward support further comprises:
a third male extension positioned within the second female groove within the forward channel in the first side support; and,
a fourth male extension positioned within the second female groove within the forward channel in the second side support;
the rotationally-molded rearward support further comprises:
a third male extension positioned within the second female groove within the rearward channel in the first side support; and,
a fourth male extension positioned within the second female groove within the rearward channel in the second side support; and,
the rotationally-molded top member further comprises:
a third male extension positioned within the second female groove within the intermediate channel in the first side support; and,
a fourth male extension positioned within the second female groove within the intermediate channel in the second side support.

12. The rotationally-molded table of claim 10 wherein:
the first rotationally-molded side support is planar;
the second rotationally-molded side support is planar;
the rotationally-molded forward support is planar;
the rotationally-molded rearward support is planar; and,
the rotationally-molded top member is planar.

13. The rotationally-molded table of claim 12 wherein:
the rotationally-molded table when unassembled has a first volume and the rotationally-molded table when assembled has a second volume; and,
a ratio of the first volume to the second volume is 40% or less.

14. A method of assembling a rotationally-molded article of furniture comprising the steps of:
(A) providing a first rotationally-molded side support comprising:
a forward channel;
a rearward channel;
an intermediate channel;
a first female groove positioned within the forward channel;
a first female groove positioned within the rearward channel; and,
a first female groove positioned within the intermediate channel;
(B) providing a second rotationally-molded side support comprising:
a forward channel;
a rearward channel;
an intermediate channel;
a first female groove positioned within the forward channel;
a first female groove positioned within the rearward channel; and,
a first female groove positioned within the intermediate channel;
(C) providing a rotationally-molded forward support comprising:
a first male extension; and,
a second male extension;
(D) providing a rotationally-molded seat member comprising:
a first male extension; and,
a second male extension;
(E) providing a rotationally-molded seat back comprising:
a first male extension; and,
a second male extension;
(F) interposing the rotationally-molded forward support between the first and second rotationally-molded side supports;
(G) positioning the first male extension of the rotationally-molded forward support within the first female groove within the forward channel in the first side support;
(H) positioning the second male extension of the rotationally-molded forward support within the first female groove within the forward channel in the second side support;
(I) interposing the rotationally-molded seat member between the first and second rotationally-molded side supports;
(J) positioning the first male extension of the rotationally-molded seat member within the first female groove within the intermediate channel in the first side support;
(K) positioning the second male extension of the rotationally-molded seat member within the first female groove within the intermediate channel in the second side support;
(L) interposing the rotationally-molded seat back between the first and second rotationally-molded side supports;
(M) positioning the first male extension of the rotationally-molded seat back within the first female groove within the rearward channel in the first side support;
(N) positioning the second male extension of the rotationally-molded seat back within the first female groove within the rearward channel in the second side support; and,
(O) using a fastener to attach the rotationally-molded seat back to the rotationally-molded seat member.

15. The method of assembling a rotationally-molded article of furniture of claim 14 wherein:
step (A) comprises the steps of:
providing a second female groove positioned within the forward channel;
providing a second female groove positioned within the rearward channel; and,
providing a second female groove positioned within the intermediate channel;
step (B) comprises the steps of:
providing a second female groove positioned within the forward channel;
providing a second female groove positioned within the rearward channel; and,
providing a second female groove positioned within the intermediate channel;
step (C) comprises the step of: providing the rotationally-molded forward support with:
a third male extension; and,
a fourth male extension;
step (D) comprises the step of: providing the rotationally-molded seat member with:
a third male extension; and,
a fourth male extension;
step (E) comprises the step of: providing the rotationally-molded seat back with:
a third male extension; and,
a fourth male extension;
after step (F) the method comprises the steps of:
positioning the third male extension of the rotationally-molded forward support within the second female groove within the forward channel in the first side support; and,
positioning the fourth male extension of the rotationally-molded forward support within the second female groove within the forward channel in the second side support;
after step (I) the method comprises the steps of:
positioning the third male extension of the rotationally-molded seat member within the second female groove within the intermediate channel in the first side support; and,
positioning the fourth male extension of the rotationally-molded seat member within the second female groove within the intermediate channel in the second side support; and,
after step (L) the method comprises the steps of:
positioning the third male extension of the rotationally-molded seat back within the second female groove within the rearward channel in the first side support; and,
positioning the fourth male extension of the rotationally-molded seat back within the second female groove within the rearward channel in the second side support.

16. The method of assembling a rotationally-molded article of furniture of claim 4 wherein:
step (D) comprises the step of: providing the rotationally-molded seat member with a slot;
step (E) comprises the step of: providing the rotationally-molded seat back with a notch tongue and a notch opening;
the method further comprises the step of: inserting the notch tongue into the slot; and,
step (O) comprises the step of: inserting the fastener into the notch opening.

17. The method of assembling a rotationally-molded article of furniture of claim 14 further comprising the step of:
providing the rotationally-molded article of furniture to be a chair of sufficient size and strength to support a typical human adult sitting on the rotationally-molded seat member.

18. The method of assembling a rotationally-molded article of furniture of claim 14 further comprising the step of:
providing the rotationally-molded article of furniture to be a couch of sufficient size and strength to support at least two typical human adults sitting side by side on the rotationally-molded seat member.

19. The method of assembling a rotationally-molded article of furniture of claim 4 wherein:
step (A) comprises the step of providing the first rotationally-molded side support to be hollow with an opening that provides access to the hollow portion;
step (B) comprises the step of providing the second rotationally-molded side support to be hollow with an opening that provides access to the hollow portion; and,
the method further comprises the step of: at least partially filling the hollow portions of the first and second rotationally-molded side supports with a weight increasing element to lessen the likelihood of wind blowing the rotationally-molded article of furniture out of place.

20. The method of assembling a rotationally-molded article of furniture of claim 19 wherein:
step (A) comprises the step of providing the first rotationally-molded side support with a cap that fits over the opening in the first rotationally-molded side support;
step (B) comprises the step of providing the second rotationally-molded side support with a cap that fits over the opening in the second rotationally-molded side support;
before the step of at least partially filling the hollow portions of the first and second rotationally-molded side supports with a weight increasing element, the method comprises the steps of:
removing the cap that fits over the opening in the first rotationally-molded side support; and,
removing the cap that fits over the opening in the second rotationally-molded side support; and,
after the step of at least partially filling the hollow portions of the first and second rotationally-molded side supports with a weight increasing element, the method comprises the steps of:
placing the cap that fits over the opening in the first rotationally-molded side support over the opening in the first rotationally-molded side support; and,
placing the cap that fits over the opening in the second rotationally-molded side support over the opening in the second rotationally-molded side support.
